(19) United States
(12) Patent Application Publication
(10) Pub. No.: US 2019/0152269 A1
(43) Pub. Date: May 23, 2019

(54) PNEUMATIC TIRE

(71) Applicant: TOYO TIRE & RUBBER CO., LTD., Itami-shi (JP)

(72) Inventor: Toshihiko Kanamura, Itami-shi (JP)

(73) Assignee: TOYO TIRE & RUBBER CO., LTD., Itami-shi (JP)

(21) Appl. No.: 16/168,348

(22) Filed: Oct. 23, 2018

(30) Foreign Application Priority Data
Nov. 22, 2017 (JP) 2017-224219

(51) Int. Cl. B60C 11/03; B60C 11/12; B60C 11/00

(52) U.S. Cl. CPC B60C 11/033; B60C 11/0332; B60C 11/1236; B60C 11/1204; B60C 2200/04; B60C 2011/036; B60C 2011/0353; B60C 2011/0355; B60C 2011/0016; B60C 11/0008

(57) ABSTRACT

A pneumatic tire includes a tread region having surface layer containing a tread surface that contacts the ground, the surface layer is formed from rubber having a rebound resilience that is 35% to 40%, the tread region includes a pair of shoulder main grooves arranged at outermost locations in a tire width direction and extending in a tire circumferential direction, and at least one center main groove arranged between the pair of shoulder main grooves and extending in the tire circumferential direction, and width of the at least one center main groove is greater than width of the shoulder main grooves.

### CROSS REFERENCE TO RELATED APPLICATIONS

This application claims the benefit of priority of Japanese application no. 2017-224219, filed on Nov. 22, 2017, which is incorporated herein by reference.

### BACKGROUND OF THE INVENTION

### Field of the Invention

The present invention relates to a pneumatic tire.

Description of the Related Art

Conventionally known as a pneumatic tire for reduction of rolling resistance is a pneumatic tire formed from prescribed rubber (e.g., Japanese Patent Application Publication Kokai No. 2016-193687). It so happens that because ground contact length (length in the tire circumferential direction of the ground contact) is greater the further inward one goes in the tire width direction, there is a tendency for water to accumulate at locations toward the interior in the tire width direction.

To address this, the pneumatic tire associated with Japanese Patent Application Publication Kokai No. 2016-193687 is such that the void ratio at shoulder regions is greater than the void ratio at a center region. But as this increases the tendency for water to accumulate at a center region, it causes a decrease in anti-hydroplaning performance (i.e., decreased ability to suppress occurrence of the phenomenon of hydroplaning).

### SUMMARY OF THE INVENTION

The problem is therefore to provide a pneumatic tire making it possible to suppress decrease in anti-hydroplaning performance while simultaneously employing rubber(s) causing reduction in rolling resistance.

There is provided a pneumatic tire, which includes:

a tread region having surface layer containing a tread surface that contacts the ground;

wherein the surface layer is formed from rubber having a rebound resilience that is 35% to 40%;

wherein the tread region comprises
a pair of shoulder main grooves arranged at outermost locations in a tire width direction and extending in a tire circumferential direction, and
at least one center main groove arranged between the pair of shoulder main grooves and extending in the tire circumferential direction; and

wherein width of the at least one center main groove is greater than width of the shoulder main grooves.

Further, the pneumatic tire may have a configuration in which:

wherein the tread region further comprises a plurality of land portions that are partitioned by the shoulder main grooves, the at least one center main groove, and grounding ends; and

wherein respective widths of shoulder land portions arranged at outermost locations in the tire width direction are greater than width of a land portion arranged toward an interior in the tire width direction.

Further, the pneumatic tire may have a configuration in which:

wherein the further outward that each of the land portions is located in the tire width direction the greater is the width of the each of the land portions.

Further, the pneumatic tire may have, a configuration in which:

wherein the further inward that each of the land portions is located in the tire width direction the greater is the void ratio of the each of the land portions.

Further, the pneumatic tire may have a configuration in which:

wherein there are two of the at least one center main groove; and

wherein area of each of the respective shoulder land portions are 20% to 25% of total area of ail of the land portions.

Further, the pneumatic tire may have a configuration in which:

wherein there is one of the at least One center main groove; and

wherein area of each of the respective shoulder land portions is 25% to 30% of total area of all of the land portions.

Further, the pneumatic tire may have a configuration in which:

wherein there are two of the at least one center main groove; and

wherein void ratio between grounding ends is 30% to 40%.

Further, the pneumatic tire may have a configuration in which:

wherein there is one of the at least one center main groove; and

wherein void ratio between grounding ends is 30% to 40%.

Further, the pneumatic tire may have a configuration in which:

wherein hardness of the rubber of the surface layer is not less than 60.

As described above, excellent benefits are provided in that a pneumatic tire is made capable of suppressing decrease in anti-hydroplaning performance while simultaneously employing rubber(s) causing reduction in rolling resistance.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing the principal components of a pneumatic tire associated with same embodiment as they would exist if unwrapped so as to lie in a single plane;

FIG. 3 is a drawing showing the ground contact shape at a pneumatic tire associated with same embodiment;

FIG. 4 is a drawing showing the principal components of a pneumatic tire associated with another embodiment as they would exist if unwrapped so as to lie in a single plane;

FIG. 5 is a table showing results of evaluation of examples and comparative examples; and

FIG. 6 is a table showing results of evaluation of examples and comparative examples.

### DETAILED DESCRIPTION GF THE INVENTION

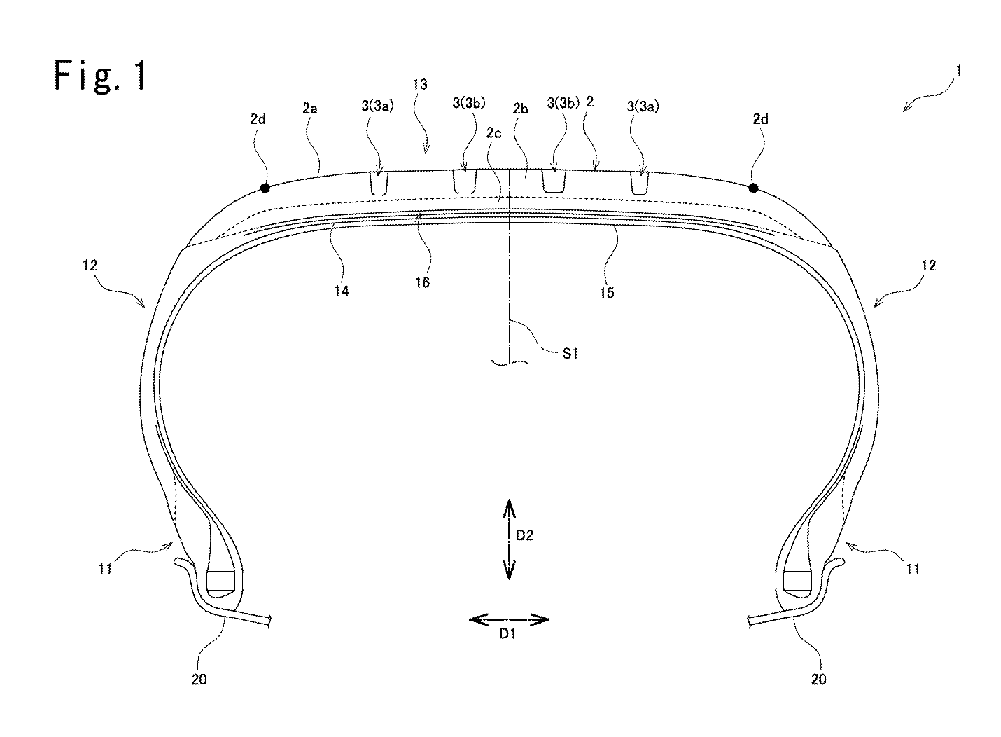

Below, an embodiment of a pneumatic tire is described with reference to FIG. 1 through FIG. 3. At the respective drawings (and the same is true for FIG. 4), note that dimensional ratios at the drawings and actual dimensional ratios are not necessarily consistent, and note further that dimensional ratios are not necessarily consistent from drawing to drawing.

At the respective drawings, first direction D1 is the tire width direction DI which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect, to the rotational axis of the tire. In addition, tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire.

As shown in FIG. 1, tire 1 associated with the present embodiment is provided with a pair of bead regions 11 at which beads are present; sidewall regions 12 Which extend outwardly in the tire/radial direction D2 from the respective bead regions 11; and tread region 13, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 14 which spans the pair of beads, and innerliner layer 15 which is arranged at a location toward the interior from carcass layer 14 and which has superior functionality in terms of its ability to impede passage of gas therethrough so as to permit air pressure to be maintained. Carcass layer 14 and innerliner layer 15 are arranged in parallel fashion with respect to the inner circumferential surface of the tire over a portion thereof that encompasses bead regions 11, sidewall regions 12, and tread region 13.

Tread region 13 is provided with tread rubber 2 having tread surface 2a which contacts the road surface, and belt layer 16 which is arranged between tread rubber 2 and carcass layer 14. Tread rubber 2 is provided with surface layer 2b which comprises tread, surface 2a, and interior layer 2c which is arranged between surface layer 2b and belt layer 16. Note that it is also possible to adopt a constitution in which interior layer 2c is not a single layer but is two or more layers.

Surface layer 2b is formed from rubber having a rebound resilience of 35% to 40%. As a result, because surface layer 2b is formed from rubber that will cause reduction in rolling resistance, it is possible to reduce the rolling resistance of tire 1. Note that rebound resilience is rebound resilience as measured at a temperature of 23° C. during Rüpke rebound resilience testing carried out in accordance with JIS K 6255. Furthermore, there is no particular limitation with respect to the rebound resilience of the rubber that forms interior layer 2c.

Present at tread surface 2a is the ground contact surface that actually comes in contact with the road surface, and the portions within said ground contact surface that are present at the outer ends in the tire width direction D1 are referred to as grounding ends 2d, 2d. Note that said ground contact surface refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface.

Normal rim 20 is that particular rim which is specified for use with a particular tire 1 in the context of the body of standards that contains the standard that applies to the tire 1 in question, this being referred to, for example, as a standard rim in the case of JATMA, a design rim in the case of TRA, or a measuring rim in the case of ETRTO.

Normal internal pressure is that air pressure which is specified for use with a particular tire 1 in the context of the body of standards that contains the standard that applies to the tire 1 in question, this being “maximum air pressure” in the case of JATMA, the maximum value listed at the table entitled “Tire Load Limits at Various Cold Inflation Pressures” in the case of TRA, or “inflation pressure” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being “maximum load capacity” in the case of JATMA, the maximum value listed at the aforementioned table in the case of TRA, or “load capacity” in the case of ETRTO, which when tire 1 is to be used on a passenger vehicle is taken to be 85% of the load corresponding to an internal pressure of 180 KPa.

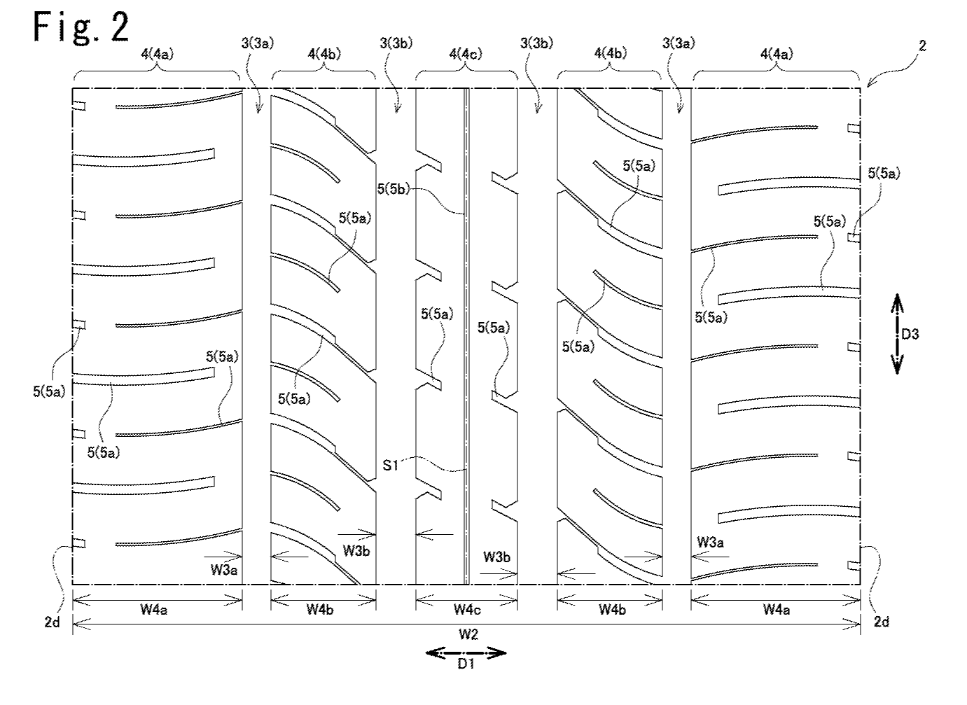

As shown in FIG. 1 and FIG. 2, tread rubber 2 is provided with a plurality of main groove's 3 (3a, 3b) extending in the tire circumferential direction D3. Main groove 3 extends continuously in the tire circumferential direction D3. Main groove 3 might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3 might, for example, have a width that is not less than 3% of the distance (dimension in the tire width direction D1) W2 between grounding ends 2d, 2d. Furthermore, main groove 3 might, for example, have a width that is not less than 5 mm.

Furthermore, at the plurality of main grooves 3, the pair of main grooves 3a, 3a arranged at outermost locations in the tire width direction D1 are referred to as shoulder main grooves 3a, and the main groove(s) 3b arranged between the pair of shoulder main grooves 3a are referred to as center main groove(s) 3b. In the present embodiment, the number of center main groove(s) 3b that are present is two.

Tread rubber 2 is provided with a plurality of land portions 4 (4a through 4c) which are partitioned toy main grooves 3 and grounding ends 2d. In the present embodiment, because the number of main, groove(s) 3 that are present is four, the number of land portion(s) 4 that are present is five.

At the plurality of land portions 4, land portion(s) 4a which are partitioned by shoulder main groove(s) 3a and grounding end(s) 2d are referred to as shoulder land portion(s) 4a. Furthermore, land portion(s) 4b which are partitioned by shoulder main groove(s) 3a and center main groove(s) 3b are referred to as mediate land portion(s) 4b, and land portion(s) 4c which are partitioned by the pair of center main grooves 3b, 3b are referred to as center land portion(s) 4c.

Land portion 4 is provided with a plurality of land grooves 5 (5a, 5b). At the plurality of land grooves 5, land groove(s) 5a which extend so as to intersect the tire circumferential direction D3 are referred to as width groove(s) 5a, and land groove(s) 5b which are separate from main grooves 3 but which extend in parallel fashion with respect to the tire circumferential direction D3 are referred to as circumferential groove(s) 5b. Note that width groove(s) 5a include narrow concavity or concavities such as those referred to as sipe(s). Furthermore, circumferential groove(s) 5b include groove(s) which are narrower than main grooves 3 and/or groove(s) which extend intermittently in the tire circumferential direction D3.

Tread rubber 2 is provided with tread pattern(s) formed by main groove(s) 3 and land groove(s) 5. In accordance with the present embodiment, tire 1 employs a symmetric tread pattern for which no vehicle mounting direction is indicated. The tread pattern at FIG. 2 is a point-symmetric tread pattern exhibiting symmetry about an arbitrary point on the tire equator where tire equatorial plane S1 and tread surface 2a intersect.

As a symmetric tread pattern for which no vehicle mounting direction is indicated, note that tire 1 may employ a line-symmetric tread pattern exhibiting symmetry about tire equatorial plane S1. Furthermore, tire 1 may employ an asymmetric tread pattern for which a vehicle mounting direction is indicated.

Next, aspects of the constitution that is characteristic of tire 1 associated with the present embodiment, as well as actions and effects thereof, will be described.

(1) While it is possible to lower rolling resistance because the rubber that forms surface layer 2b has a rebound resilience of 35% to 40%, there is a tendency for the rigidity of land portion(s) 4 to decrease. As a result, there is concern that there could be decrease in cornering power, causing reduction in performance with respect to stability in handling during turns.

Width (the dimension in the tire width direction D1) W4a of each shoulder land portion 4a is therefore made larger than widths (the dimensions in the tire width direction D1) W4b of mediate land portions 4b and width (the dimension in the tire width direction D1) W4c of center land portion 4c. In addition, it is preferred that the area of each shoulder land portion 4a (including land groove(s) 5) be not less than 20% of the total area of all land portions 4 (including land groove(s) 5).

As a result, because shoulder land portion 4a will be of adequate size, this will make it possible to suppress reduction in rigidity at shoulder land portion 4a. Because this will make it possible to suppress decrease in cornering power, it will therefore make it possible to suppress reduction in performance with respect to stability in handling during turns.

(2) But, during driving, the amount of elastic deformation at shoulder land portion 4a will be greater than the amount of elastic deformation at either mediate land portion 4b or center land portion 4c. As a result, the energy loss at shoulder land portion 4a will be greater than the energy loss at either mediate land portion 4b or center land portion 4c.

It is therefore preferred that the area of each shoulder land portion 4a be not greater than 25% of the total area of all land portions 4. As a result, because a situation in which the size of shoulder land portion 4a becomes too large will have been prevented, this will make it possible to suppress increase in energy loss at shoulder land portion 4a. This will therefore make it possible to suppress increase in rolling resistance.

(3) Furthermore, it is preferred that surface layer 2b be formed from rubber having a hardness that is not less than 60. This will make it possible to suppress reduction in rigidity at land portion 4. Note that hardness is hardness as measured at 23° C. using a durometer hardness test apparatus (Type A) in accordance with JIS K 6253. Moreover, causing surface layer 2b to be formed from rubber having a hardness that is not greater than 65 will permit actions and effects of the constitution having the foregoing and the following characteristic aspects to be exhibited in marked fashion. Furthermore, there is no particular limitation with respect to the hardness of the rubber that forms interior layer 2c.

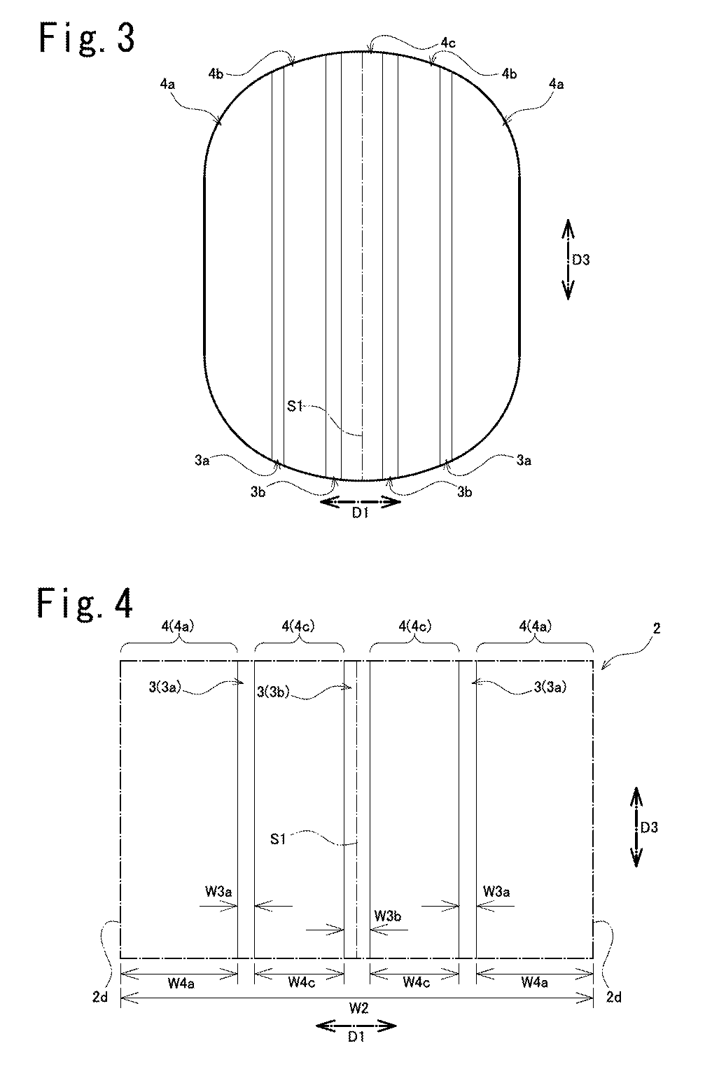

(4) Furthermore, the ground contact shape when driving straight ahead (see FIG. 3; note that land groove(s) 5 are not shown at FIG. 3) is such that ground contact length (length in the tire circumferential direction D3) is greater the further inward (the nearer to tire equatorial plane S1) one goes in the tire width direction D1. As a result, there is a tendency for accumulation of water to occur at center main groove(s) 3b which are arranged toward the interior in the tire width direction D1.

Width(s) W3b of center main groove(s) 3b are therefore made larger than width(s) W3a of shoulder main groove(s) 3a. In addition, it is preferred that width(s) W3b of center main groove(s) 3b be 110% to 150% of width(s) W3a of shoulder main groove(s) 3a. As a result, because it will be possible to suppress the tendency for water to accumulate at center main groove(s) 3b, this will make it possible to suppress decrease in anti-hydroplaning performance.

Moreover, it is preferred, at a tire meridional plane section, that groove area at center main groove(s) 3b be greater than groove area at shoulder main groove(s) 3a. That is, it is preferred that groove volume at center main groove(s) 3b be greater than groove volume at shoulder main groove(s) 3a. This will make it possible to effectively suppress the tendency for water to accumulate at center main groove(s) 3b.

In accordance with the present embodiment, groove depth at center main groove(s) 3b is the same as groove depth at shoulder main groove(s) 3a. Note that it is also possible to adopt a constitution in which, for example, to improve performance with respect to water shedding by center main groove(s) 3b and to increase rigidity at shoulder land portion(s) 4a, groove depth at center main groove(s) 3b is greater than groove depth at shoulder main groove(s) 3a. Furthermore, it is also possible to adopt a constitution in which, for example, to suppress occurrence of situations in which rigidity at center land portion(s) 4c is too low, groove depth at center main groove(s) 3b is less than groove depth at shoulder main groove(s) 3a.

Furthermore, it is preferred that width(s) W4c of center land portion(s) 4c be not greater than 22% of distance W2 between grounding ends 2d, 2d. Where this is the case, because center main groove(s) 3b, 3b will be arranged toward the interior in the tire width direction D1, it will be possible to increase the water shedding effect attributable to center main groove(s) 3b. Moreover, to prevent rigidity at center land portion(s) 4c from becoming too low, it is preferred that width(s) W4c of center land portion(s) 4c be not less than 10% of distance W2 between grounding ends 2d, 2d.

Moreover, it is preferred that the void ratio between grounding ends 2d, 2d at tread surface 2a be not less than 30%. Where this is the case, because it will be possible, by preventing occurrence of a situation in which the void ratio is too low, to cause water shedding to occur in appropriate fashion, this will make it possible to suppress decrease in anti-hydroplaning performance. Note that void ratio is the ratio of groove area (the sum of the area of main groove(s) 3 and the area of land groove(s) 5) to ground contact area (the sum of the area of main groove(s) 3 and the area of land portion(s) 4 (including land groove(s) 5)) that is the area between grounding ends 2d, 2d.

In addition, it is preferred that the void ratio attributable to main groove(s) 3 between grounding ends 2d, 2d at tread surface 2a be not less than 20%. Where this is the case, because it will be possible for main groove(s) 3 to carry out water shedding inappropriate fashion, this will make it possible to suppress decrease in anti-hydroplaning performance. Note that the void ratio attributable to main groove(s) 3 is the ratio of the area of main groove(s) 3 to the area of the ground contact.

(5) But if the void ratio becomes too large, this will cause decrease in rigidity at land portion(s) 4. It is therefore preferred that the void ratio between grounding ends 2d, 2d at tread surface 2a be not greater than 40%. In addition, it is preferred that the void ratio attributable to main groove(s) 3 between grounding ends 2d, 2d at tread surface 2a be not greater than 30%. This will make it possible to suppress reduction in rigidity at land portion(s) 4.

Furthermore, it is preferred that the void ratio attributable to land groove(s) 5 between grounding ends 2d, 2d at tread surface 2a be not greater than 10%. This will make it possible to suppress reduction in rigidity at land portion(s) 4. Note that the void ratio attributable to land groove(s) 5 is the ratio of the area of land groove(s) 5 to the area of the ground contact.

(6) Moreover, width(s) W4a of shoulder land portion(s) 4a are greater than width(s) W4b of mediate land portion(s) 4b, and width(s) W4b of mediate land portion(s) 4b are greater than width(s) W4c of center land portion(s) 4c. While this causes ground contact length to be greater the further inward one goes in the tire width direction D1, it also causes rigidity of land portion(s) 4 to be greater the further outward one goes in the tire width direction D1.

Accordingly, because ground contact shape is made stable, it is possible, for example, to suppress occurrence of situations in which there are locations at which ground, contact length decreases in such fashion as to be directed toward the interior in the tire width direction D1 (i.e., situations in which ground contact shape is such that there are locations along the outer edge thereof that are irregular). Accordingly, it is possible to suppress occurrence of situations in which ground contact pressure is nonuniform.

As a result, because it will be possible, for example, to suppress situations in which strain increases as a result of increase in ground contact pressure toward the exterior in the tire width direction D1, this will make it possible to suppress increase in rolling resistance. Furthermore, because this will make it possible, for example, to suppress occurrence of situations in which there is decrease in frictional resistance and decrease in lateral force during turns, it will make it possible to suppress decrease in performance with respect to stability in handling during turns.

(7) Furthermore, the void ratio at center land portion(s) 4c is greater than the void ratio at mediate land portion(s) 4b, and the void ratio at mediate land portion(s) 4b is greater than the void ratio at shoulder land portion(s) 4a. As a result, the void ratio at land portion(s) 4 will be greater the further inward one goes in the tire width direction D1.

Accordingly, because the void ratio at center land portion(s) 4c will be high, a large number of land grooves 5 are provided at center land portion(s) 4c, for which ground contact length is large. As a result, at center land portion(s) 4c, because performance with respect to water shedding is improved, it will be possible to improve anti-hydroplaning performance. Furthermore, because the void ratio at shoulder land portion(s) 4a will be low, this will make it possible to suppress decrease in rigidity at shoulder land portion(s) 4a. Because this will make it possible to suppress decrease in cornering power, it will therefore make it possible to suppress reduction in performance with respect to stability in handling during turns.

As described above, the pneumatic tire 1 of the embodiment include a tread region 13 having surface layer 2b containing a tread surface 2a that contacts the ground, wherein the surface layer 2b is formed from rubber having a rebound resilience that is 35% to 40%, wherein the tread region 13 comprises a pair of shoulder main grooves 3a, 3a arranged at outermost locations in a tire width direction D1 and extending in a tire circumferential direction D3, and at least one center main groove 3b arranged between the pair of shoulder main grooves 3a, 3a and extending in the tire circumferential direction D3, and wherein width W3b of the at least one center main groove 3b is greater than width W3a of the shoulder main grooves 3a.

In accordance with such constitution, that portion of tread region 13 which corresponds to surface layer 2b and contains the tread surface 2a that comes in contact with the ground is formed from rubber having a rebound resilience of 35% to 40%. Where this is the case, the rubber employed at surface layer 2b will be rubber that will cause reduction in rolling resistance.

But because ground contact length is greater the further inward one goes in the tire width direction D1, there is a tendency for accumulation of water to occur at center main groove(s) 3b which are arranged toward the interior in the tire width direction D1. Width(s) W3b of center main groove(s) 3b are therefore made larger than width(s) W3a of shoulder main groove(s) 3a. Where this is the case, because it will be possible to suppress the tendency for water to accumulate at center main groove(s) 3b, this will make it possible to suppress decrease in anti-hydroplaning performance.

In the pneumatic tire 1 of the embodiment, wherein the tread region 13 further comprises a plurality of land portions 4 that are partitioned by the shoulder main grooves 3a, the at least one center main groove 3b, and grounding ends 2d, and wherein respective widths W4a of shoulder land portions 4a arranged at outermost locations in the tire width direction D1 are greater than width W4b, W4c of a land portion 4b, 4c arranged toward an interior in the tire width direction D1.

In accordance with such constitution, causing this to be formed from rubber having a rebound resilience of 35% to 40% results in a situation in which there is a tendency for rigidity at land portion(s) 4 to decrease, for which reason width(s) W4a of land portions 4a arranged at outermost locations in the tire width direction D1 are made greater than widths W4b, W4c of land portions 4b, 4c arranged toward the interior in the tire width direction D1. This suppresses reduction in rigidity at land portions 4a arranged at outermost locations in the tire width direction D1.

In the pneumatic tire 1 of the embodiment, wherein the further outward that each of the land portions 4a through 4c is located in the tire width direction D1 the greater is the width W4a through W4c of the each of the land portions 4a through 4c.

In accordance with such constitution, ground contact length is greater the further inward one goes in the tire width direction D1, for which reason land portions 4a through 4c are made to be such that the further outward that a land portion 4a through 4c is located in the tire width direction D1 the greater is the width W4a through W4c thereof. Where this is the case, because land portions 4a through 4c will be such that the further outward that a land portion 4a through 4c is located in the tire width direction D1 the greater will be the rigidity thereof, this causes ground contact shape to be made stable.

In the pneumatic tire 1 of the embodiment, wherein the further inward that each of the land portions 4a through 4c is located in the tire width direction D1 the greater is the void ratio of the each of the land portions 4a through 4c.

In accordance with such constitution, because land portions 4a through 4c are such that the further inward that a land portion 4c, 4b, 4a is located in the tire width direction D1 the greater is the void ratio thereof, land portion(s) 4c located toward the interior in the tire width direction D1 have large ground contact length but are provided with a large number of groove components (land grooves 5). This improves performance with respect to water shedding at land portion(s) 4c located toward the interior in the tire width direction D1. What is more, it is possible to suppress reduction in rigidity at land portions 4a located toward the exterior in the tire width direction D1.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that the number of center main grooves 3b that are present is two. However, pneumatic tire 1 is not limited to such constitution. For example, it is also possible to adopt a constitution in which the number of center main grooves 3b that are present is three or more, and as shown in FIG. 4 it is also possible to adopt a constitution in which the number of center main groove 3b that are present is one.

Below, the constitution of pneumatic tire 1 associated with FIG. 4 is described. At FIG. 4, note that land grooves 5 are not shown.

At FIG. 4, because the number of main grooves 3 that are present is three, the number of land portions 4 that are present is four. At the plurality of land portions 4, each land portion 4a which is partitioned by each shoulder main groove 3a and grounding end 2d is referred, to as shoulder land portion 4a, and land portion 4c which is partitioned by each shoulder main groove 3a and center main groove 3b is referred to as center land, portion 4c.

At center main groove 3b, to suppress occurrence of situations in which water accumulates, width W3b of center main groove 3b are made larger than width W3a of each shoulder main groove 3a. Furthermore, to suppress decrease in rigidity at each shoulder land portion 4a, and to cause ground contact shape to be made to have stable shape, width W4a of each shoulder land, portion 4a is made larger than width W4c of center land portion 4c.

In addition, it is preferred that area of each shoulder land portion 4a be not less than 25% of the total area of all land portions 4. Where this is the case, because it will be possible to prevent a situation in which the size of shoulder land portion 4a becomes too small, this will make it possible to suppress decrease in rigidity at shoulder land portion 4a. On the other hand, it is preferred that area of each shoulder land portion 4a be not greater than 30% of the total area of all land portions 4. As a result, because it will be possible to prevent a situation in which the size of shoulder land portion 4a becomes too large, this will make it possible to suppress increase in energy loss at shoulder land portion 4a.

Furthermore, it is preferred that the void ratio between grounding ends 2d, 2d at tread surface 2a be not less than 30%. Where this is the case, because it will be possible to prevent occurrence of a situation in which the void ratio is too low, this will make it possible to cause water shedding to occur in appropriate fashion. On the other hand, it is preferred that the void ratio between grounding ends 2d, 2d at tread surface 2a be not greater than 40%. Where this is the case, because it will be possible to prevent occurrence of a situation in which the void ratio is too high, this will make it possible to suppress decrease in rigidity at land portion(s) 4.

(2) Furthermore, the constitution of pneumatic tire 1 associated with the foregoing embodiment is such that width(s) W4a of land portion(s) 4a arranged at outermost locations in the tire width direction D1 are greater than width(s) W4b, W4c of land portion(s) 4b, 4c arranged toward the interior in the tire width direction D1. While such constitution is preferred, pneumatic tire 1 is not limited to such constitution. For example, it is also possible to adopt a constitution in which width(s) W4a of land portion(s) 4a arranged at outermost locations in the tire width direction D1 are less than width(s) W4b, W4c of land portion(s) 4b, 4c arranged toward the interior in the tire width direction D1.

(3) Furthermore, the constitution of pneumatic tire 1 associated with the foregoing embodiment is such that the further outward that a land portion 4a through 4c is located in the tire width direction D1 the greater is the width W4a through W4c of that land portion 4a through 4c. While such constitution is preferred, pneumatic tire 1 is not limited to such constitution. For example, it is also possible to adopt a constitution in which the further outward that a land portion 4a through 4c is located in the tire width direction D1 the smaller is the width W4 a through W4c of that land portion 4a through 4c.

(4) Furthermore, the constitution of pneumatic tire 1 associated with the foregoing embodiment is such that the further inward that a land portion 4c, 4b, 4a is located in the tire width direction D1 the greater is the void ratio of that land portion 4a through 4c. While such constitution is preferred, pneumatic tire 1 is not limited to such constitution. For example, it is also possible to adopt a constitution in which the further inward that a land portion 4c, 4b, 4a is located in the tire width direction D1 the smaller is the void ratio of that land portion 4a through 4c.

(5) Furthermore, the constitution of pneumatic tire 1 associated with the foregoing embodiment is such that main groove(s) 3 extend in parallel fashion with respect to the tire circumferential direction D3. However, pneumatic tire 1 is not limited to such constitution. For example, it is also possible to adopt a constitution in which main groove(s) 3 extend in zigzag fashion along the tire circumferential direction D3.

(6) Furthermore, the constitution of pneumatic tire 1 associated with the foregoing embodiment is such that width(s) W3a through W3d of main groove(s) 3a through 3d are the same at all locations in the tire circumferential direction D3. However, pneumatic tire 1 is not limited to such constitution. For example, it is also possible to adopt a constitution in which width(s) W3a through W3d of main groove(s) 3a through 3d vary. In the context of such constitution, width(s) W3a through W3d of main groove(s) 3a through 3d are the average value(s) of width(s) W3a through W3d of main groove(s) 3a through 3d.

(7) Furthermore, the constitution of pneumatic tire 1 associated with the foregoing embodiment is such that width(s) W4a through W4e of land portion(s) 4a through 4e are the same at all locations in the tire circumferential direction D3. However, pneumatic tire 1 is not limited to such constitution. For example, it is also possible to adopt a constitution in which width(s) W4a through W4e of land portion(s) 4a through 4e vary. In the context of such constitution, width(s) W4a through W4e of land portion(s) 4a through 4e are the average value(s) of width(s) W4a through W4e of land portion(s) 4a through 4e.

### EXAMPLES

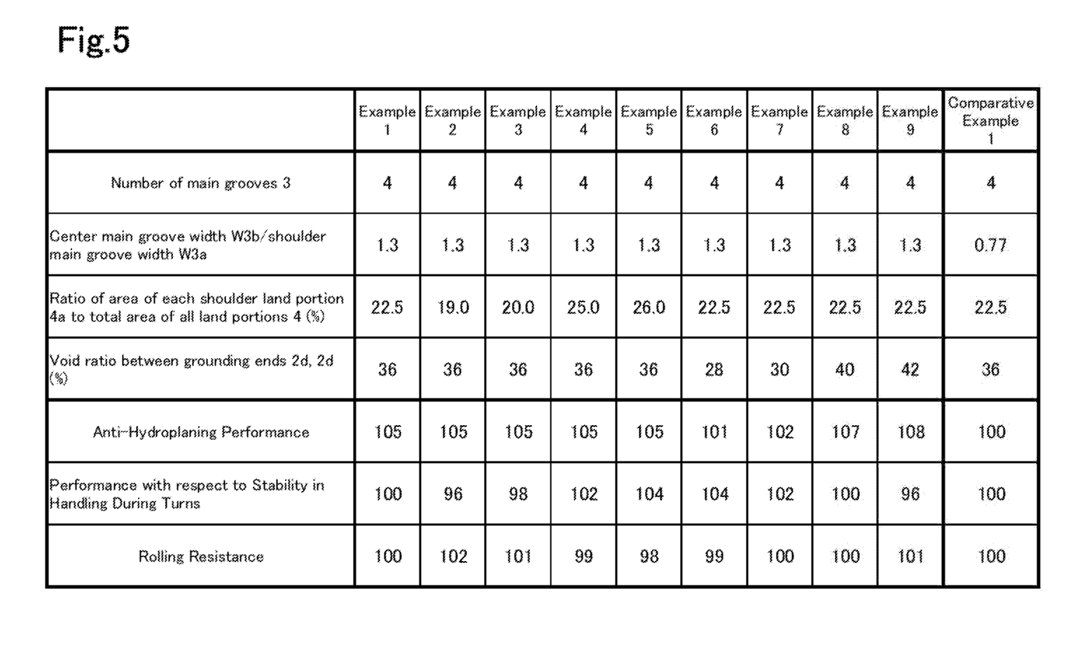

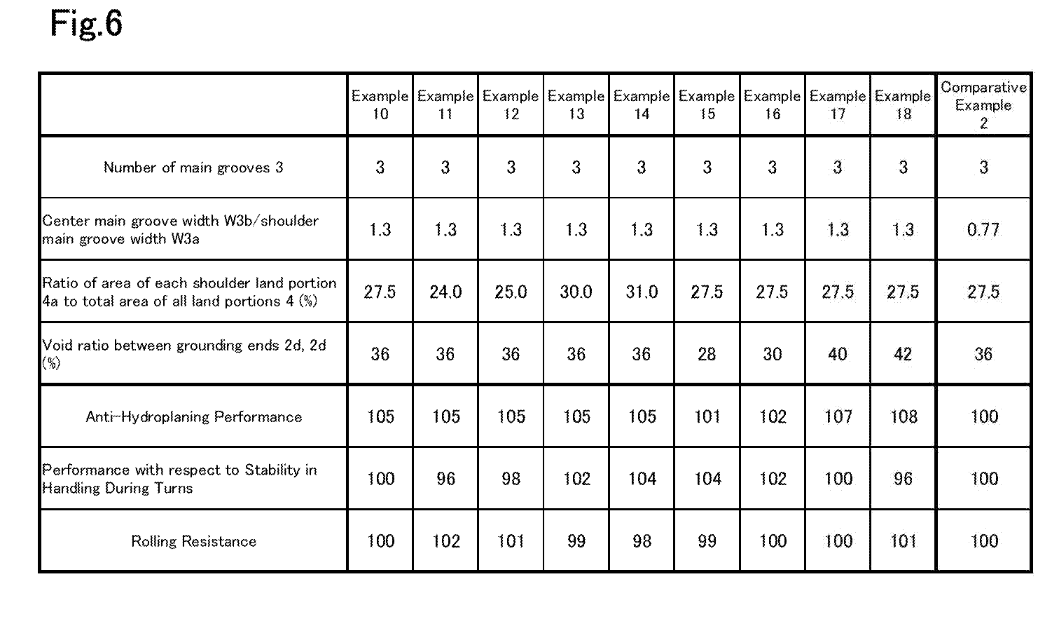

To illustrate the constitution and effect of tire 1 in specific terms, Examples of tire 1 as well as comparative examples thereof are described below with reference to FIG. 5 and FIG. 6.

<Anti-Hydroplaning Performance>

The respective tires were mounted on a vehicle, and with wheels on one side traveling straight ahead on a wet road for which water depth was 8 mm and wheels on the other side traveling straight ahead on a dry road, the speed necessary to cause the difference in percent slip between the left-side wheels and right-side wheels to reach 10% was measured. Results of evaluation are shown as indexed relative to a value of 100 for the comparative examples (Comparative Example 1 for Examples 1 through 9; Comparative Example 2 for Examples 10 through 18), the larger the index the less likely the tendency for hydroplaning to occur and the better the anti-hydroplaning performance.

<Performance with respect to Stability in Handling During Turns>

The respective tires were mounted on a vehicle, and driving was carried cut with turning on a dry road. In addition, sensory tests carried put by the driver were employed for the purpose of evaluating stability in handling. Results of evaluation are shown as indexed relative to a value of 100 for the comparative examples (Comparative Example 1 for Examples 1 through 9; Comparative Example 2 for Examples 10 through 18), the larger the index the better the stability in handling.

<Rolling Resistance>

After mounting the respective tires on rims, rolling resistance was measured in accordance with International Standard ISO 28580 (JIS D 4234). Results of evaluation are shown as indexed relative to a value of 100 for the comparative examples (Comparative Example 1 for Examples 1 through 9; Comparative Example 2 for Examples 10 through 18), the larger the index the lower, and better, the rolling resistance.

### Example 1

Example 1 was a tire which had the following constitution.

1) Number of main grooves 3=4

2) Rebound resilience (23° C.)=38%

3) Hardness (23° C.)=61

4) Center main groove width W3b/shoulder main groove width W3a=1.3

5) Ratio or area of each shoulder land portion 4a to total area of all land portions 4=22.5%

6) Ratio of area of each mediate land portion 4b to total area of all land portions 4=18.5%

7) Ratio of area of center land portion 4c to total area of all land portions 4=18.0%

8) Void ratio between grounding ends 2d, 2d at tread surface 2a=36%

9) Void ratio attributable to main grooves 3=29%

10) Void ratio attributable to land grooves 5=7%

### Example 2

Constitution of the tire of Example 2 was different from the constitution of tire 1 of Example 1 with respect to the following points.

5) Ratio of area of each shoulder land portion 4a to total area of all land portions 4=19.0%

6) Ratio of area of each mediate land portion 4b to total area of all land portions 4=20.0%

7) Ratio of area of center land portion 4c to total area of all land portions 4=20.2%

### Example 3

Constitution of the tire of Example 3 was different from the constitution of tire 1 of Example 1 with respect to the following points.

5) Ratio of area of each shoulder land portion 4a to total area, of all land portions 4 = 20.0%

6) Ratio of area of each mediate land portion 4b to total area of all land portions 4=20.2%

7) Ratio of area of center land portion 4c to total area of all land portions 4=19.6%

### Example 4

Constitution of the tire of Example 4 was different from the constitution of tire 1 of Example 1 with respect to the following points.

5) Ratio of area of each shoulder land portion 4a to total area of all land portions 4=25.0%

6) Ratio of area of each mediate land portion 4b to total, area of all land portions 4=16.8%

7) Ratio of area of center land portion 4c to total area of all land portions 4=16.4%.

### Example 5

Constitution of the tire of Example 5 was different from the constitution of tire 1 of Example 1 with respect to the following points.

5) Ratio of area of each shoulder land portion 4a to total area of all land portions 4=26.0%

6) Ratio of area of each mediate land portion 4b to total area of all land portions 4=16.1%

7) Ratio of area of center land portion 4c to total area of all land portions 4=15.8%

### Example 6

Constitution of the tire of Example 6 was different from the constitution of tire 1 of Example 1 with respect to the following points.

8) Void ratio between grounding ends 2d, 2d at tread surface 2a=28%

9) Void ratio attributable to main grooves 3=24%

10) Void ratio attributable to land grooves 5=4%

### Example 7

Constitution of the tire of Example 7 was different from the constitution of tire 1 of Example 1 with respect to the following points.

8) Void ratio between grounding ends 2d, 2d at tread surface 2a=30%

9) Void ratio attributable to main grooves 3=25%

10) Void ratio attributable to land grooves 5=5%

### Example 8

Constitution of the tire of Example 8 was different from the constitution of tire 1 of Example 1 with respect to the following points.

8) Void ratio between grounding ends 2d, 2d at tread surface 2a=40%

9) Void ratio attributable to main grooves 3=30%

10) Void ratio attributable to land grooves 5=10%

### Example 3

Constitution of the tire of Example 9 was different from the constitution of tire 1 of Example 1 with respect to the following points.

8) Void ratio between grounding ends 2d, 2d at tread surface 2a=42%

9) Void ratio attributable to main grooves 3=31%

10) Void ratio attributable to land grooves 5=11%

### Comparative Example 1

Constitution of the tire of Comparative Example 1 was different from the constitution of tire 1 of Example 1 with respect to the following points.

4) Center main groove width W3b/shoulder main groove width W3a=0.77 (=1/1.3)

### Example 10

Example 10 was a tire which had the following constitution.

1) Number of main grooves 3=3

2) Rebound resilience (23° C.)=38%

3) Hardness (23° C.)=61

4) Center main groove width W3b/shoulder main groove width W3a=1.3

5) Ratio of area of each shoulder land portion 4a to total area of all land portions 4=27.5%

6) Ratio of area of each center land portion 4c to total area of all land portions 4=22.5%

7) Void ratio between grounding ends 2d, 2d at tread surface 2a=36%

8) Void ratio attributable to main grooves 3=29%

9) Void ratio attributable to land grooves 5=7%

### Example 11

Constitution of the tire of Example 11 was different from the constitution of tire 1 of Example 10 with respect to the following points.

5) Ratio of area of each shoulder land portion 4a to total area of all land portions 4=24.0%

6) Ratio of area of each center land portion 4c to total area of all land portions 4=26.0%

### Example 12

Constitution of the tire of Example 12 was different from the constitution of tire 1 of Example 10 with respect to the following points.

5) Ratio of area of each shoulder land portion 4a to total area of all land portions 4=25.0%

6) Ratio of area of each center land portion 4c to total area of all land portions 4=25.0%

### Example 13

Constitution of the tire of Example 13 was different from the constitution of tire 1 of Example 10 with respect to the following points.

5) Ratio of area of each shoulder land portion 4a to total area of all land portions 4=30.0%

6) Ratio of area of each center land portion 4c to total area of all land portions 4=20.0%

### Example 14

Constitution of the tire of Example 14 was different from the constitution of tire 1 of Example 10 with respect to the following points.

5) Ratio of area of each shoulder land portion 4a to total area of all land portions 4=31.0%

6) Ratio of area of each center land portion 4c to total area of all land portions 4=19.0%

### Example 15

Constitution of the tire of Example 15 was different from the constitution of tire 1 of Example 10 with respect to the following points.

7) Void ratio between grounding ends 2d, 2d at tread surface 2a>28%

8) Void ratio attributable to main grooves 3=24%

9) Void ratio attributable to land grooves 5=4%

### Example 16

Constitution of the tire of Example 16 was different from the constitution of tire 1 of Example 10 with respect to the following points.

7) Void ratio between grounding ends 2d, 2d at tread surface 2a=30%

8) Void ratio attributable to main grooves 3=25%

9) Void ratio attributable to land grooves 5=5%

### Example 17

Constitution of the tire of Example 17 was different from the constitution of tire 1 of Example 10 with respect to the following points.

7) Void ratio between grounding ends 2d, 2d at tread surface 2a=40%

8) Void ratio attributable to Main grooves 3=30%

9) Void ratio attributable to land grooves 5=10%

### Example 18

Constitution of the tire of Example 18 was different from the constitution of tire 1 of Example 10 with respect to the following points.

7) Void ratio between grounding ends 2d, 2d at tread surface 2a=42%

8) Void ratio attributable to main grooves 3=31%

9) Void ratio attributable to land grooves 5=11%

### Comparative Example 2

Constitution of the tire of Comparative Example 2 was different from the constitution of tire 1 of Example 10 with respect to the following points.

4) Center main groove width W3b/shoulder main groove width W3a=0.77 (=1/1.3)

<Results of Evaluation>

As shown in FIG. 5 and FIG. 6, anti-hydroplaning performance is greater than 100 at all of Examples 1 through 18. Accordingly, by causing widths W3b of center main grooves 3b to be larger than widths W3a of shoulder main grooves 3a, it was possible to suppress decrease in anti-hydroplaning performance while simultaneously employing rubber causing reduction in rolling resistance.

Furthermore, a preferred Example of a tire is described below.

Whereas the difference between rolling resistance and performance with respect to stability in handling during turns was 6 at Examples 2 and 5, the difference between rolling resistance and performance with respect to stability in handling during turns was 3 or less at Examples 1, 3, and 4. This being the case, it was more possible at Examples 1, 3, and 4 than at Examples 2 and 5 to simultaneously achieve satisfactory rolling resistance and performance with respect to stability in handling during turns.

Accordingly, in the context of a constitution in which the number of center main groove(s) 3b that are present is two, because it will be possible, by causing the area of each of shoulder land portions 4a to be 20% to 25% of the total area of all land portions 4, to simultaneously achieve satisfactory rolling resistance and performance with respect to stability in handling during turns in even better fashion, this is preferred. It should be noted, of course, that tire 1 is not limited to such range.

Whereas the difference, between rolling resistance and performance with respect to stability in handling during turns was 5 at Examples 6 and 9, the difference between rolling resistance and performance with respect to stability in handling during turns was 2 or less at Examples 1, 7, and 8. This being the case, it was more possible at Examples 1, 7, and 8 than at Examples 6 and 9 to simultaneously achieve satisfactory rolling resistance and performance with respect, to stability in handling during turns.

Accordingly, in the context of a constitution in which the number of center main groove(s) 3b that are present is two, because it will be possible, by causing the void ratio between grounding ends 2d, 2d at tread surface 2a to be 30% to 40%, to simultaneously achieve satisfactory rolling resistance and performance with respect to stability in handling during turns in even better fashion, this is preferred. It should be noted, of course, that tire 1 is not limited to such range.

Whereas the difference between rolling resistance and performance with respect to stability in handling during turns was 6 at Examples 11 and 14, the difference between rolling resistance and performance with respect to stability in handling during turns was 3 or less at Examples 10, 12, and 13. This being the case, it was more possible at Examples 10, 12, and 13 than at Examples 11 and 14 to simultaneously achieve satisfactory rolling resistance and performance with respect to stability in handling during turns.

Accordingly, in the context of a constitution in which the number of center main groove(s) 3b that are present is one, because it will be possible, by causing the area of each of shoulder land portions 4a to be 25% to 30% of the total area of all land portions 4, to simultaneously achieve satisfactory rolling resistance and performance with respect to stability in handling during turns in even better fashion, this is preferred. It should be noted, of course, that tire 1 is not limited to such range.

Whereas the difference between rolling resistance and performance with respect to stability in handling during turns was 5 at Examples 15 and 18, the difference between rolling resistance and performance with respect to stability in handling during turns was 2 or less at Examples 10, 16, and 17. This being the case, it was more possible at Examples 10, 16, and 17 than at Examples 15 and 18 to simultaneously achieve satisfactory rolling resistance and performance with respect to stability in handling during turns.

Accordingly, in the context of a constitution in which the number of center main groove(s) 3b that are present is one, because it will be possible, by causing the void ratio between grounding ends 2d, 2d at tread surface 2a to be 30% to 40%, to simultaneously achieve satisfactory rolling resistance and performance with respect to stability in handling during turns in even better fashion, this is preferred. It should be noted, of course, that tire 1 is not limited to such range.

What is claimed is:

1. A pneumatic tire comprising a tread region having surface layer containing a tread surface that contacts the ground;
wherein the surface layer is formed from rubber having a rebound resilience that is 35% to 40%;
wherein the tread region comprises
a pair of shoulder main grooves arranged at outermost locations in a tire width direction and extending in a tire circumferential direction, and
at least one center main groove arranged between the pair of shoulder main grooves and extending in the tire circumferential direction; and
wherein width of the at least one center main groove is greater than width of the shoulder main grooves.

2. The pneumatic tire according to claim 1
wherein the tread region further comprises a plurality of land portions that are partitioned by the shoulder main grooves, the at least one center main groove, and grounding ends; and
wherein respective widths of shoulder land portions arranged at outermost locations in the tire width direction are greater than width of a land portion arranged toward an interior in the tire width direction.

3. The pneumatic tire according to claim 2
wherein the further outward, that each of the land portions is located in the tire width direction the greater is the width of the each of the land portions.

4. The pneumatic tire according to claim 1
wherein the further inward that each of the land portions is located in the tire width direction the greater is the void ratio of the each of the land portions.

5. The pneumatic tire according to claim 2
wherein there are two of the at least one center main groove; and
wherein area of each of the respective shoulder land portions are 20% to 25% of total area of ail of the land portions.

6. The pneumatic tire according to claim 2
wherein there is one of the at least one center main groove; and
wherein area of each of the respective shoulder land portions is 25% to 30% of total area of all of the land portions.

7. The pneumatic tire according to claim 1
wherein there are two of the at least one center main groove; and
wherein void ratio between grounding ends is 30% to 40%.

8. The pneumatic tire according to claim 1
wherein there is one of the at least one center main groove; and
wherein void ratio between grounding ends is 30% to 40%.

9. The pneumatic tire according to claim 1
wherein hardness of the rubber of the surface layer is not less than 60.
